(19) United States
(12) Patent Application Publication
(10) Pub. No.: US 2013/0218934 A1
(43) Pub. Date: Aug. 22, 2013

(54) METHOD FOR DIRECTORY ENTRIES SPLIT AND MERGE IN DISTRIBUTED FILE SYSTEM

(71) Applicants: Wujuan LIN, Singapore (SG); Kenta SHIGA, Singapore (SG)

(72) Inventors: Wujuan LIN, Singapore (SG); Kenta SHIGA, Singapore (SG)

(73) Assignee: HITACHI, LTD., Tokyo (JP)

(21) Appl. No.: 13/399,657

(22) Filed: Feb. 17, 2012

(51) Int. Cl. G06F 17/30

(52) U.S. Cl. 707/828; 707/E17.01

(57) ABSTRACT

A distributed storage system has MDSs (metadata servers). Directories of file system namespace are distributed to the MDSs based on hash value of inode number of each directory. Each directory is managed by a master MDS. When a directory grows with a file creation rate greater than a preset split threshold, the master MDS constructs a consistent hashing overlay with one or more slave MDSs and splits directory entries of the directory to the consistent hashing overlay based on hash values of file names under the directory. The number of MDSs in the consistent hashing overlay is calculated based on the file creation rate. When the directory continues growing with a file creation rate that is greater than the preset split threshold, the master MDS adds a slave MDS into the consistent hashing overlay and splits directory entries to the consistent hashing overlay based on hash values of file names.

### BACKGROUND OF THE INVENTION

The present invention relates generally to storage systems and, more particularly to a method for distributing directory entries to multiple metadata servers in a distributed system environment.

Recently technologies in distributed file system, such as parallel network file system (pNFS) and the like, enable an asymmetric system architecture, which consists of a plurality of data servers and metadata servers. In such a system, file contents are typically stored in the data servers, and metadata (e.g., file system namespace tree structure and location information of file contents) are stored in the metadata servers. Clients first consult the metadata servers for the location information of file contents, and then access file contents directly from the data servers. By separating the metadata access from the data access, the system is able to provide very high IO throughput to the clients. One of the major use cases for such a system is high performance computing (HPC) application.

Although metadata are relatively small in size compared to file contents, the metadata operations may make up as much as half of all file system operations, according to studies done. Therefore, effective metadata management is critically important for the overall system performance. Modern HPC applications can use hundreds of thousands of CPU cores simultaneously for a single computation task. Each CPU core may steadily create files for various purposes, such as checkpoint files for failure recovery and intermediate computation results for post-processing (e.g., visualization, analysis), resulting in millions of files in a single directory with a high file creation rate. A single metadata server is not sufficient to handle such file creation workload. Distributing such workload to multiple metadata servers hence raises an important challenge for the system design.

Traditional metadata distribution methods fall into two categories, namely, sub-tree partitioning and hashing. In a sub-tree partitioning method, the entire file system namespace is divided into sub-trees and assigned to different metadata servers. In a hashing method, individual file/directory is distributed based on the hash value of some unique identifier, such as inode number or path name. Both the sub-tree partitioning and hashing methods have limited performance for file creation in a single directory. This is because in a file system, to maintain the namespace tree structure, a parent directory consists of a list of directory entries, each representing a child file/directory under the parent directory. Creating a file in a parent directory presents the need to update the parent directory by inserting a directory entry for the newly created file. As both sub-tree partitioning and hashing methods store a directory and its directory entries in a single metadata server, the process to update the directory entries are handled by only one metadata server, hence limiting the file creation performance.

In order to increase the file creation performance in a single directory, U.S. Pat. No. 5,893,086 discloses a method to distribute the directory entries into multiple buckets, based on extensible hashing technology, in a shared disk storage system. Each bucket has the same size (e.g., file system block size), and directory entries can be inserted into the buckets in parallel. To insert a new directory entry to a bucket, if the bucket is full, a new bucket is added and part of the existing directory entries in the overflowed bucket will be moved to the new bucket based on the recalculated hash value. After that, the new directory entry can be inserted. To remove a directory entry from a bucket due to file deletion, if the bucket becomes empty, the empty bucket will be also removed. To look up a directory entry, the system will construct a binary hash tree based on the number of buckets (file system blocks) allocated to the directory, and traverse the tree bottom up, until a bucket consists of the directory entry is found.

### BRIEF SUMMARY OF THE INVENTION

Exemplary embodiments of the invention provide a method for distributing directory entries to multiple metadata servers to improve the performance of file creation under a single directory, in a distributed system environment. The method disclosed in U.S. Pat. No. 5,893,086 is limited to a shared disk environment. Extension of this method to a distributed storage environment, where each metadata server has its own storage, is unknown and nontrivial. Firstly, as the hash tree is not explicitly maintained for a directory, it is difficult to determine to which metadata server a directory entry should be created. Secondly, when a directory entry is migrated from one metadata server to another, the corresponding file should be migrated as well to retain namespace consistency in both metadata servers. Efficient file migration method is needed to minimize the impact to file creation performance for user applications. Lastly, it is more desired that the number of metadata servers to which directory entries are distributed can be dynamically changed based on file creation rate instead of file number.

Specific embodiments of the invention are directed to a method to split directory entries to multiple metadata servers to enable parallel file creation under single directory, and merge directory entries of a split directory into one metadata server when the directory shrinks or has no more file creation. Each metadata server (MDS) maintains a global Consistent Hash (CH) Table, which consists of all the MDSs in the system. Each MDS is assigned a unique ID and manages one hash value range (or ID range of hash values) in the global CH Table. Directories are distributed to the MDSs based on the hash value of their inode numbers. When a directory has high file creation rate, the MDS, which manages the directory (referred to as master MDS), will select one or more other MDSs (referred to as slave MDSs), and construct a local CH Table with the slave MDSs and the master MDS itself. The number of slave MDSs is determined based on the file creation rate. The local CH Table is stored in the directory inode. After that, the master MDS will create the same directory to each slave MDS and start to split the directory entries to the slave MDSs based on the hash values of file names. To split the directory entries to a slave MDS, the master MDS will first send only the hash values of the file names to the slave MDS. The corresponding files will be migrated later by a file migration program with minimal impact to file creation performance. Files can be created in parallel to the master MDS and slave MDSs as soon as hash values have been sent to the slave MDSs.

After the file migration process is completed, if the master MDS or a slave MDS detects high file create rate again, more slave MDSs can be add to the local CH Table to further split the directory entries and share the file creation workload. On the other hand, if a slave MDS detects that the directory has no more file creation, or low file creation rate, it can request the master MDS to remove it from the local CH Table and merge the directory entries to the next MDS in the local CH Table, by first sending the hash values of file names, then migrating the files.

To read a file in a split directory, the request is sent to the MDS (either master MDS or slave MDS) directly based on the hash value. To read the entire directory (e.g., readdir), the request is sent to all the MDSs in the local CH Table and the results are combined. This invention can be used to design a distributed file system to support large file creation rate under a single directory with scalable performance, by using multiple metadata servers.

An aspect of the present invention is directed to a plurality of MDSs (metadata servers) in a distributed storage system which includes data servers storing file contents to be accessed by clients, each MDS having a processor and a memory and storing file system metadata to be accessed by the clients. Directories of a file system namespace are distributed to the MDSs based on a hash value of inode number of each directory, each directory is managed by a MDS as a master MDS of the directory, and a master MDS may manage one or more directories. When a directory grows with a high file creation rate that is greater than a preset split threshold, the master MDS of the directory constructs a consistent hashing overlay with one or more MDSs as slave MDSs and splits directory entries of the directory to the consistent hashing overlay based on hash values of file names under the directory. The consistent hashing overlay has a number of MDSs including the master MDS and the one or more slave MDSs, the number being calculated based on the file creation rate. When the directory continues growing with a file creation rate that is greater than the preset split threshold, the master MDS adds a slave MDS into the consistent hashing overlay and splits directory entries of the directory to the consistent hashing overlay with the added slave MDS based on hash values of file names under the directory.

In some embodiments, when the file creation rate of the directory drops below a preset merge threshold, the master MDS removes a slave MDS from the consistent hashing overlay and merges the directory entries of the slave MDS to be removed to a successor MDS remaining in the consistent hashing overlay. Each MDS includes a directory entry split module configured to: calculate a file creation rate of a directory; check whether a status of the directory is split or normal which means not split; if the status is normal and if the file creation rate is greater than the preset split threshold, then split the directory entries for the directory to the consistent hashing overlay based on hash values of file names under the directory; and if the status is split and if the file creation rate is greater than the preset split threshold, then send a request to the master MDS of the directory to add a slave MDS to the consistent hashing overlay if the MDS of the directory entry split module is not the master MDS, and add a slave MDS to the consistent hashing overlay if the MDS of the directory entry split module is the master MDS.

In specific embodiments, each MDS maintains a global consistent hashing table which stores information of all the MDSs. Splitting the directory entries by the directory entry split module of the master MDS for the directory comprises: selecting one or more other MDSs as slave MDSs from the global consistent hashing table, wherein the number of slave MDSs to be selected is calculated by rounding up a value of a ratio of (the file creation rate/the preset split threshold) to a next integer value and subtracting 1; creating the same directory to each of the selected slave MDSs; and splitting the directory entries to the selected slave MDSs based on the hash values of file names under the directory, by first sending only the hash values of the file names to the slave MDSs and migrating files corresponding to the file names later. Files can be created in parallel to the master MDS and the slave MDSs as soon as hash values have been sent to the slave MDSs. Each MDS comprises a file migration module configured to: as a source MDS for file migration, send a directory name of the directory and a file to be migrated to a destination MDS; and as a destination MDS for file migration, receive the directory name of the directory and the file to be migrated from the source MDS, and create the file to the directory.

In some embodiments, each MDS maintains a global consistent hashing table which stores information of all the MDSs. The directory entry split module which sends a request to the master MDS of the directory to add a slave MDS to the consistent hashing overlay is configured to: find the master MDS of the directory by looking up the global consistent hashing table; send an “Add” request to the master MDS of the directory; receive information of a new slave MDS to be added; and send a directory name of the directory and hash values of file names of files to be migrated to the new slave MDS.

In specific embodiments, each MDS maintains a global consistent hashing table which stores information of all the MDSs, and each MDS includes a consistent hashing module. For adding a new slave MDS into the consistent hashing overlay, the consistent hashing module in the master MDS is configured to select the new slave MDS from the global consistent hashing table, assign to the new slave MDS a unique ID representing an ID range of hash values in the consistent hashing overlay to be managed by the new slave MDS, add the new slave MDS to the consistent hashing overlay, and, if the new slave MDS is added in response to a request from another MDS, then send a reply with the unique ID and an IP address of the new slave MDS to the MDS which sent the request for adding the new slave MDS. For merging directory entries of a MDS which is to be removed to a successor MDS, the consistent hashing module of the master MDS is configured to send the IP address of the successor MDS to the MDS which is to be removed, and remove the MDS from the consistent hashing overlay. The unique ID assigned to the new slave MDS represents an ID range of hash values equal to half of the ID range of hash values, which is managed by the MDS that sent the request for adding the new slave MDS, prior to adding the new slave MDS.

In specific embodiments, each MDS maintains a global consistent hashing table which stores information of all the MDSs, and each MDS includes a directory entry merge module. The directory entry split module is configured to, if the status is split and if the file creation rate is smaller than the preset merge threshold, then invoke the directory entry merge module to merge the directory entries of the MDS to be removed. The invoked directory entry merge module is configured to: find the master MDS of the directory by looking up the global consistent hashing table; and if the MDS of the invoked directory merge module is not the master MDS of the directory, then send a “Merge” request to the master MDS of the directory to merge the directory entries of the MDS to a successor MDS in the consistent hashing overlay, receive information of the successor MDS, send a directory name of the directory and hash values of file names of files to be migrated to the successor MDS and migrate files corresponding to the file names later, and delete the directory from the MDS to be removed.

In some embodiments, the master MDS of a directory includes a directory inode comprising an inode number column of a unique identifier assigned for the directory and for each file in the directory, a type column indicating “File” or “Directory,” an ACL column indicating access permission of the file or directory, a status column for the directory indicating split or normal which means not split, a local consistent hashing table column, a count column indicating a number of directory entries for the directory, and a checkpoint column. The master MDS constructs a local consistent hashing table associated with the consistent hashing overlay, which is stored in the local consistent hashing table column if the status is split. A checkpoint under the checkpoint column is initially set to 0 and can be changed when the directory entries are split or merged.

In some embodiments, the master MDS of the directory has a quota equal to 1 and each slave MDS has a quota equal to a ratio between capability of the slave MDS to capability of the master MDS. Each MDS includes a directory entry split module configured to: calculate a file creation rate of a directory; check whether a status of the directory is split or normal which means not split; if the status is normal and if the file creation rate is greater than the preset split threshold multiplied by the quota of the MDS of the directory entry split module, then split the directory entries for the directory to the consistent hashing overlay based on hash values of file names under the directory; and if the status is split and if the file creation rate is greater than the preset split threshold multiplied by the quota of the MDS of the directory entry split module, then send a request to the master MDS of the directory to add a slave MDS to the consistent hashing overlay.

In some embodiments, each MDS maintains a global consistent hashing table which stores information of all the MDSs, and each MDS includes a consistent hashing module. For adding a new slave MDS into the consistent hashing overlay, the consistent hashing module in the master MDS is configured to select the new slave MDS from the global consistent hashing table, assign to the new slave MDS a unique ID representing an ID range of hash values in the consistent hashing overlay to be managed by the new slave MDS, add the new slave MDS to the consistent hashing overlay, and, if the new slave MDS is added in response to a request from another MDS, then send a reply with the unique ID and an IP address of the new slave MDS to the MDS which sent the request for adding the new slave MDS. For merging directory entries of a MDS which is to be removed to a successor MDS, the consistent hashing module of the master MDS is configured to send the IP address of the successor MDS to the MDS which is to be removed, and remove the MDS from the consistent hashing overlay. The unique ID assigned to the new slave MDS represents an ID range of hash values equal to a portion of the ID range of hash values, which is managed by the MDS that sent the request for adding the new slave MDS, prior to adding the new slave MDS, such that a ratio of the portion of the ID range to be managed by the new slave MDS and a remaining portion of the ID range to be managed by the MDS that sent the request is equal to a ratio of the quota of the new slave MDS and the quota of the MDS that sent the request.

In specific embodiments, a distributed storage system includes one or more clients, one or more data servers storing file contents to be accessed by the clients, and the plurality of MDSs. Each MDS maintains and each client maintains a global consistent hashing table which stores information of all the MDSs. Each client has a processor and a memory, and is configured to find the master MDS of the directory by looking up the global consistent hashing table and to send a directory access request of the directory directly to the master MDS of the directory.

In some embodiments, a distributed storage system comprises: the plurality of MDSs; one or more clients; one or more data servers storing file contents to be accessed by the clients; a first network coupled between the one or more clients and the MDSs; and a second network coupled between the MDSs and the one or more data servers. The MDSs serve both metadata access from the clients and file content access from the clients via the MDSs to the data servers.

Another aspect of the invention is directed to a method of distributing directory entries to a plurality of MDSs in a distributed storage system which includes clients and data servers storing file contents to be accessed by the clients, each MDS storing file system metadata to be accessed by the clients. The method comprises: distributing directories of a file system namespace to the MDSs based on a hash value of inode number of each directory, each directory being managed by a MDS as a master MDS of the directory, wherein a master MDS may manage one or more directories; when a directory grows with a high file creation rate that is greater than a preset split threshold, constructing a consistent hashing overlay with one or more MDSs as slave MDSs and splits directory entries of the directory to the consistent hashing overlay based on hash values of file names under the directory, wherein the consistent hashing overlay has a number of MDSs including the master MDS and the one or more slave MDSs, the number being calculated based on the file creation rate; and when the directory continues growing with a file creation rate that is greater than the preset split threshold, adding a slave MDS into the consistent hashing overlay and splits directory entries of the directory to the consistent hashing overlay with the added slave MDS based on hash values of file names under the directory.

These and other features and advantages of the present invention will become apparent to those of ordinary skill in the art in view of the following detailed description of the specific embodiments.

### BRIEF DESCRIPTION OF THE DRAWINGS

FIG. 1 is an exemplary diagram of an overall system according to a first embodiment of the present invention.

FIG. 2 is a block diagram illustrating the components within a metadata server.

FIG. 3 shows a high level overview of a logical architecture of the metadata servers organized into a consistent hashing overlay.

FIG. 4 shows an example of a global consistent hash (CH) table maintained in a metadata server (MDS) according to the first embodiment.

FIG. 5 shows an example of a file system namespace hierarchy and the structure of a directory entry.

FIG. 6 shows an example illustrating directories being distributed to the metadata servers (MDSs).

FIG. 7 is a flow diagram illustrating the exemplary steps of a path traversal process.

FIG. 8 shows an example of the structure of an inode according to the first embodiment.

FIG. 9 is a flow diagram illustrating the exemplary steps of transferring a file access request from the current MDS to the master MDS of the file.

FIG. 10 is a flow diagram illustrating the exemplary steps of file creation executed by the master MDS of the file.

FIG. 11 is a flow diagram illustrating exemplary steps of a directory entry split program.

FIG. 12 is a flow diagram illustrating the exemplary steps to calculate the file create rate.

FIG. 13 is a flow diagram illustrating the exemplary steps to split the directory entries.

FIG. 14 shows an example of the IDs assigned to the MDSs in the local CH table.

FIG. 15 shows an example of the structure of a file migration table.

FIG. 16 is a flow diagram illustrating exemplary steps of a file migration program.

FIG. 17 is a flow diagram illustrating the exemplary steps to add a slave MDS to the local CH table.

FIG. 18 is a flow diagram illustrating exemplary steps of a CH program executed by the master MDS of a directory.

FIG. 19 shows an example of the ID assigned to the new slave MDS in the local CH table.

FIG. 20 is a flow diagram illustrating exemplary steps of a directory entry merge program.

FIG. 21 is a flow diagram illustrating exemplary steps of a file read process in the master MDS of the file.

FIG. 22 is a flow diagram illustrating exemplary steps of the process to read all the directory entries in a directory (readdir), executed in a MDS which receives the request.

FIG. 23 shows an example of a local CH table maintained in a MDS according to the second embodiment, and an example of three MDSs in the local CH table, which logically form a consistent hashing overlay with ID space.

FIG. 24 shows an example of the structure of an inode according to the second embodiment, where a quota column is added.

FIG. 25 is an exemplary diagram of an overall system according to a fourth embodiment of the present invention.

### DETAILED DESCRIPTION OF THE INVENTION

In the following detailed description of the invention, reference is made to the accompanying drawings which form a part of the disclosure, and in which are shown by way of illustration, and not of limitation, exemplary embodiments by which the invention may be practiced. In the drawings, like numerals describe substantially similar components throughout the several views. Further, it should be noted that while the detailed description provides various exemplary embodiments, as described below and as illustrated in the drawings, the present invention is not limited to the embodiments described and illustrated herein, but can extend to other embodiments, as would be known or as would become known to those skilled in the art. Reference in the specification to “one embodiment,” “this embodiment,” or “these embodiments” means that a particular feature, structure, or characteristic described in connection with the embodiment is included in at least one embodiment of the invention, and the appearances of these phrases in various places in the specification are not necessarily all referring to the same embodiment. Additionally, in the following detailed description, numerous specific details are set forth in order to provide a thorough understanding of the present invention. However, it will be apparent to one of ordinary skill in the art that these specific details may not all be needed to practice the present invention. In other circumstances, well-known structures, materials, circuits, processes and interfaces have not been described in detail, and/or may be illustrated in block diagram form, so as to not unnecessarily obscure the present invention.

Furthermore, some portions of the detailed description that follow are presented in terms of algorithms and symbolic representations of operations within a computer. These algorithmic descriptions and symbolic representations are the means used by those skilled in the data processing arts to most effectively convey the essence of their innovations to others skilled in the art. An algorithm is a series of defined steps leading to a desired end state or result. In the present invention, the steps carried out require physical manipulations of tangible quantities for achieving a tangible result. Usually, though not necessarily, these quantities take the form of electrical or magnetic signals or instructions capable of being stored, transferred, combined, compared, and otherwise manipulated. It has proven convenient at times, principally for reasons of common usage, to refer to these signals as bits, values, elements, symbols, characters, terms, numbers, instructions, or the like. It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

The present invention also relates to an apparatus for performing the operations herein. This apparatus may be specially constructed for the required purposes, or it may include one or more general-purpose computers selectively activated or reconfigured by one or more computer programs. Such computer programs may be stored in a computer-readable storage medium, such as, but not limited to optical disks, magnetic disks, read-only memories, random access memories, solid state devices and drives, or any other types of media suitable for storing electronic information. The algorithms and displays presented herein are not inherently related to any particular computer or other apparatus. Various general-purpose systems may be used with programs and modules in accordance with the teachings herein, or it may prove convenient to construct a more specialized apparatus to perform desired method steps. In addition, the present invention is not described with reference to any particular programming language. It will be appreciated that a variety of programming languages may be used to implement the teachings of the invention as described herein. The instructions of the programming language(s) may be executed by one or more processing devices, e.g., central processing units (CPUs), processors, or controllers.

Exemplary embodiments of the invention, as will be described in greater detail below, provide apparatuses, methods and computer programs for distributing directory entries to multiple metadata servers to improve the performance of file creation under a single directory, in a distributed system environment.

### Embodiment 1

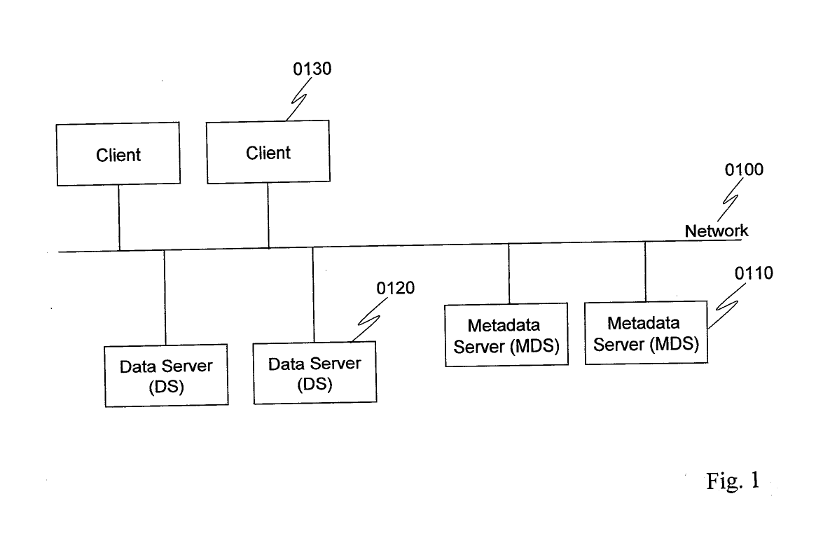

FIG. 1 is an exemplary diagram of an overall system according to a first embodiment of the present invention. The system includes a plurality of Metadata Servers (MDSs) 0110, Data Servers (DSs) 0120, and Clients 0130 connected to a network 0100 (such as a local area network). MDSs 0110 are the metadata servers where the file system metadata (e.g., directories and location information of file contents) are stored. Data servers 0120 are the devices, such as conventional NAS (network attached storage) devices, where file contents are stored. Clients 0130 are devices (such as PCs) that access the metadata from MDSs 0110 and the file contents from DSs 0120.

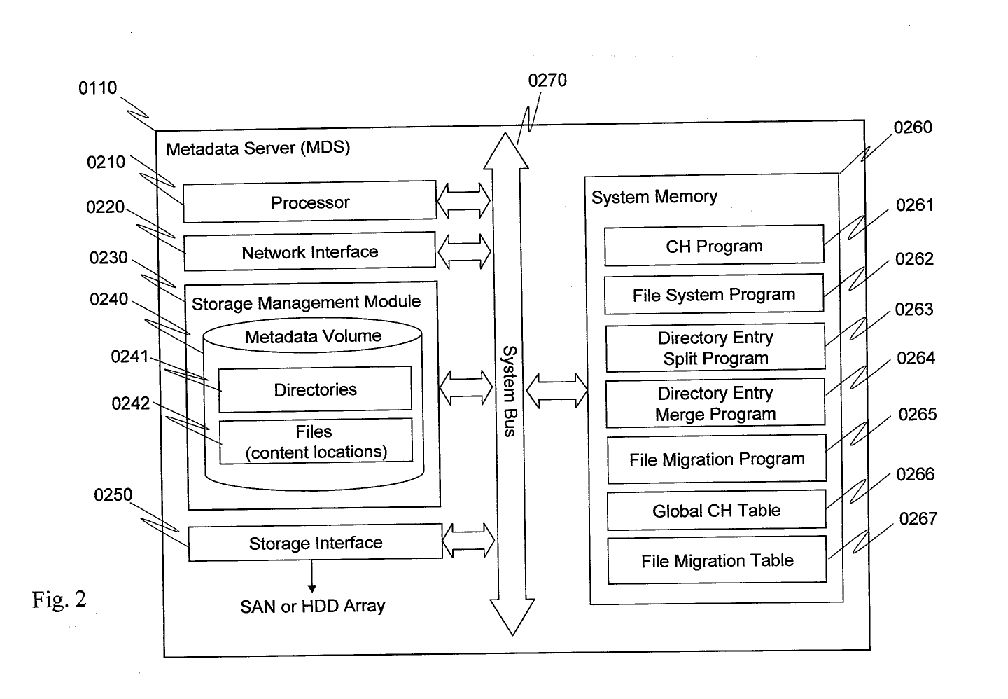

FIG. 2 is a block diagram illustrating the components within a MDS 0110. The MDS may include, but is not limited to, a processor 0210, a network interface 0220, a storage management module 0230, a storage interface 0250, a system memory 0260, and a system bus 0270. The system memory 0260 includes a CH (consistent hashing) program 0261, a file system program 0262, a directory entry split program 0263, a directory entry merge program 0264, and a file migration program 0265, which are computer programs to be executed by the processor 0210. The system memory 0260 further includes a global CH table 0266 and a file migration table 0267 which are read from and/or written to by the programs. The storage interface 0250 manages the storage from a storage area network (SAN) or an internal hard disk drive (HDD) array, and provides raw data storage to the storage management module 0230. The storage management module 0230 organizes the raw data storage into a metadata volume 0240, where directories 0241, and files 0242 which consist of only file contents location information, are stored. The directories 0241 and files 0242 are read from and/or written to by the file system program 0262. The network interface 0220 connects the MDS 0110 to the network 0100 and is used to communicate with other MDSs 0110, DSs 0120, and Clients 0130. The processor 0210 represents a central processing unit that executes the computer programs. Commands and data communicated among the processor and other components are transferred via the system bus 0270.

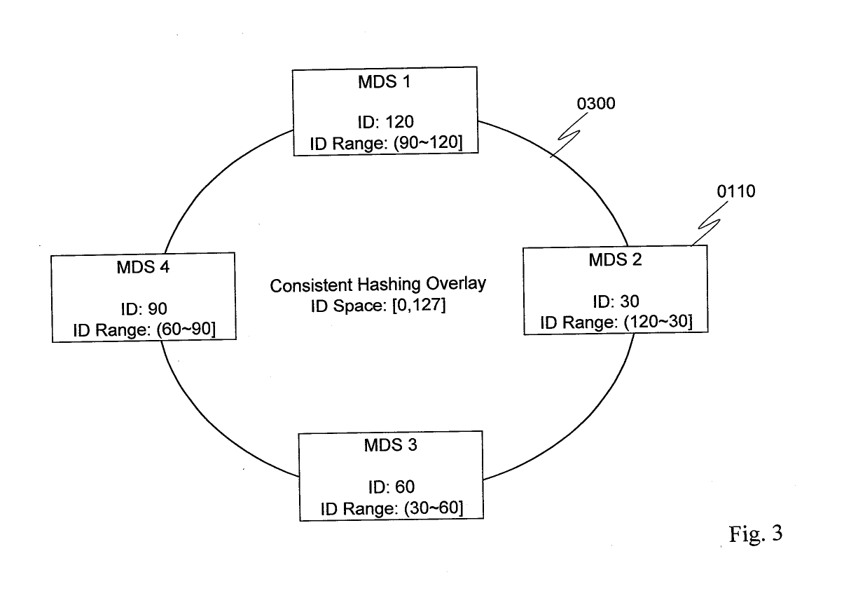

FIG. 3 shows a high level overview of a logical architecture of the MDSs 0110, where the MDSs 0110 are organized into a consistent hashing overlay 0300. A consistent hashing overlay 0300 manages an ID space, organized into a logical ring where the smallest ID succeeds the largest ID. Each MDS 0110 has a unique ID in a consistent hashing overlay 0300, and is responsible for a range of ID space (i.e., ID range of hash values) that has no overlap with the ID ranges managed by other MDSs 0110 in the same consistent hashing overlay. FIG. 3 also shows the ID range managed by each MDS 0110 in a consistent hashing overlay 0300 with ID space [0,127]. It should be noted that the ID space forms a circle, and therefore the ID range managed by the MDS with ID 120 is (90λ120], the ID range managed by the MDS with ID 30 is (120˜30], and the ID range managed by the MDS with ID 60 is (30˜60], and so on.

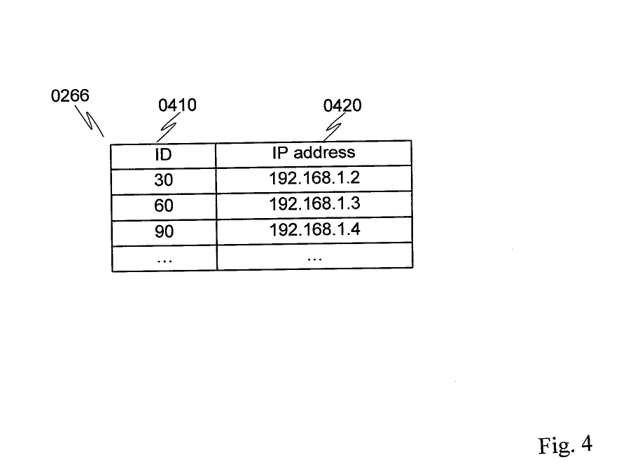

FIG. 4 shows an example of a global CH table 0266 maintained in a MDS 0110 according to the first embodiment. Each MDS 0110 maintains a global CH table 0266, which stores information of all the MDSs 0110 in the system that logically form a consistent hashing overlay 0300, referred to as the global consistent hashing overlay. Each row entry in the global CH table 0266 represents the information of a MDS 0110, which may consist of, but is not limited to, two columns, including ID 0410 and IP address 0420. ID 0410 is obtained from the hash value of the IP address 0420, by executing the hash function in the CH program 0261. With a collision-free hash function, such as 160-bit SHA-1 or the like, the ID assigned to a MDS 0110 will be globally unique.

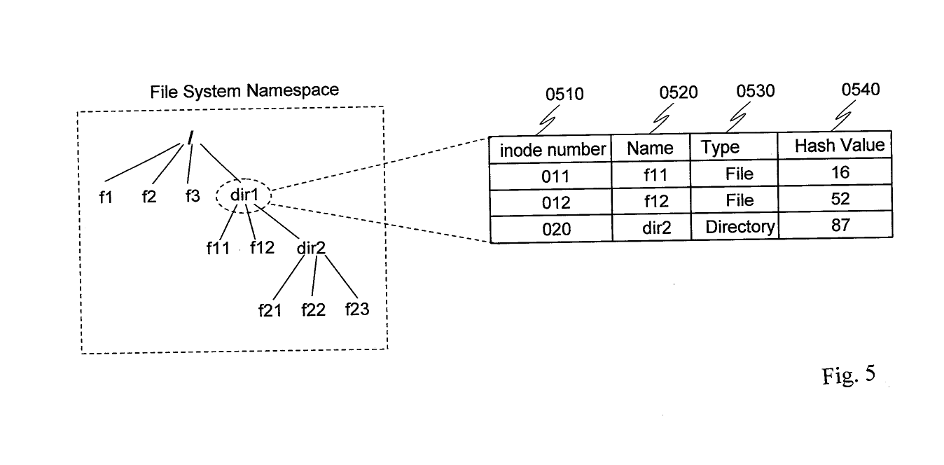

FIG. 5 shows an example of a file system namespace hierarchy, which consists of 3 directories, “/,” “dir1,” and “dir2.” Further, for each directory, the information of the sub-files and sub-directories under the directory is stored as the content of the directory, referred to as Directory Entries. FIG. 5 also shows an example of the structure of a Directory Entry, which consists of, but is not limited to, inode number 0510, name 0520, type 0530, and hash value 0540. The inode number 0510 is a unique identifier assigned for the sub-file/sub-directory by the file system program 0262. The name 0520 is the sub-file/sub-directory name. The type 0530 is either “File” or “Directory.” The hash value 0540 for a directory entry with type 0530 as “File” is obtained by calculating the hash value of the file name 0520, while hash value 0540 for a directory entry with type 0530 as “Directory” is obtained by calculating the hash value of the inode number 0510. It may be noted that root directory “/” is a special directory whose inode number 0510 is known by all the MDSs 0110.

Metadata of file system namespace hierarchical structure, i.e., directories, are distributed to all the MDSs 0110 based on the global CH table 0266. More specifically, a directory is stored in the MDS 0110 (referred to as master MDS of the directory) which manages the ID range in which the hash value 0540 of the directory falls.

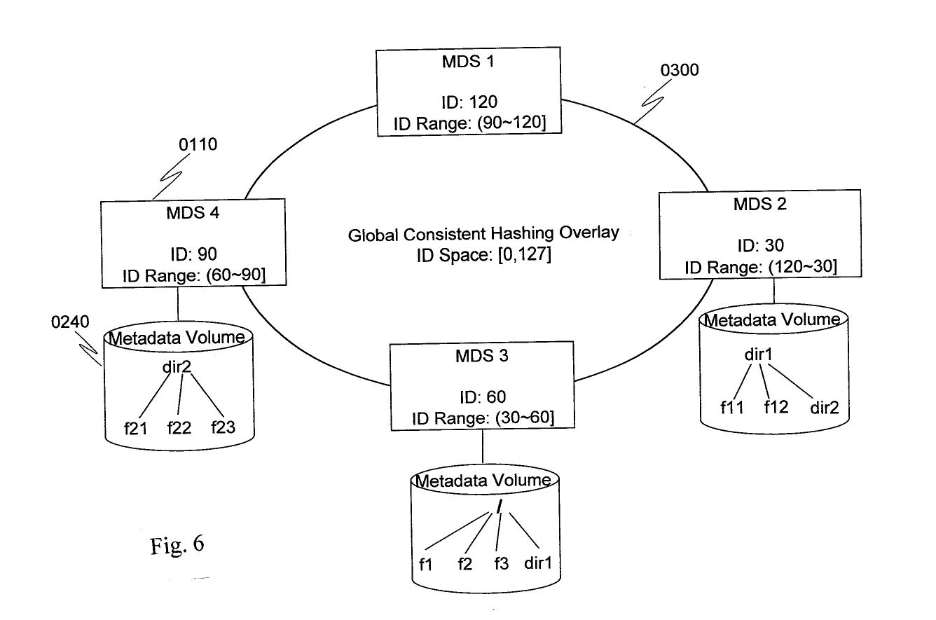

FIG. 6 shows an example illustrating directories (with reference to FIG. 5) being distributed to the MDSs 0110. As seen in the example, directory “dir2” has a hash value of 87, and therefore, it is stored in the MDS which manages the ID range (60˜90]. To access a file, a path traversal from the root to the parent directory of the requested file is required for checking the access permission, for each directory along the path.

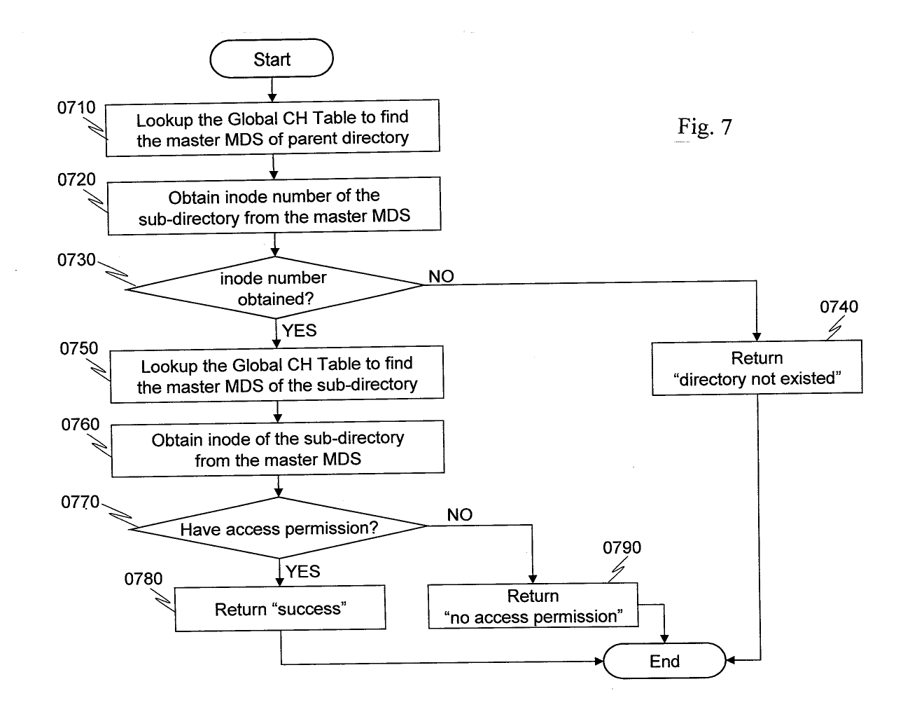

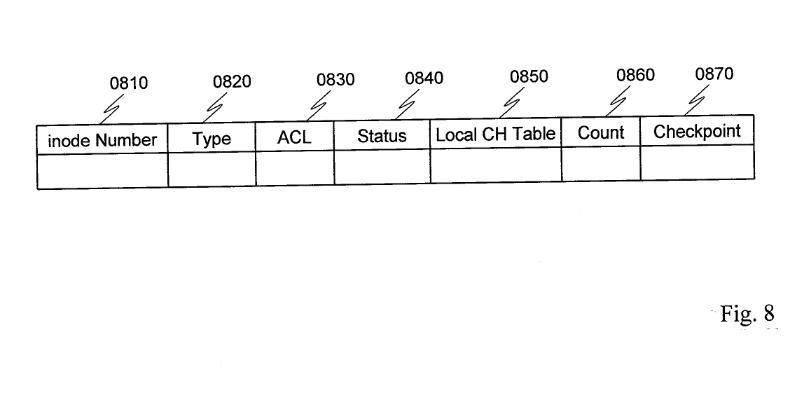

FIG. 7 is a flow diagram illustrating the exemplary steps of the path traversal process to check if a client has the access permission to a sub-directory in the path by being given the inode number of its parent directory. This process is executed by a MDS 0110, referred to as the current MDS, which receives the path traversal request from a client 0130, by executing the file system program 0262. In Step 0710, the current MDS first calculates the hash value of the parent inode number, and then finds the master MDS, which manages the ID range in which the hash value falls, by looking up the global CH table 0266. In Step 0720, the current MDS obtains the inode number of the sub-directory from the master MDS found in Step 0710, by searching sub-directory in the parent directory entries stored in the master MDS. In Step 0730, the current MDS checks if the inode number of the sub-directory is obtained. If NO, in Step 0740, the current MDS returns “directory not existed” to the client 0130. If YES, in Step 0750, the current MDS calculates the hash value of the sub-directory inode number, and then finds the master MDS of the sub-directory, by looking up the global CH table 0266. In Step 0760, the current MDS obtains the inode (refer to FIG. 8) of the sub-directory from its master MDS found in Step 0750. In Step 0770, the current MDS checks if the client 0130 has the access permission to the sub-directory. If NO, in Step 0790, the current MDS returns “no access permission” to the client 0130. If YES, the current MDS then returns “success” to the client 0130 in Step 0780. It may be noted that, after Step 0760, the sub-directory inode can be cached at the current MDS, so that subsequent access to the sub-directory inode can be performed locally. Revalidation techniques found in existing arts, such as those in NFS (network file system), can be used to ensure that when the directory inode in the master MDS is changed, the cached inode in the current MDS can be updated through revalidation.

FIG. 8 shows an example of the structure of an inode according to the first embodiment. An inode consists of, but is not limited to, seven columns, including inode number 0810, type 0820, ACL 0830, status 0840, local CH table 0850, count 0860, and checkpoint 0870. The inode number 0810 is a unique identifier assigned for the file/directory. The type 0820 is either “File” or “Directory.” The ACL 0830 is the access permission of the file/directory. The status 0840 is either “split” or “normal.” Initially, the status 0840 is set to “normal.” For a directory inode, the status 0840 may be changed to “split” from “normal” by the directory entry split program 0263, and changed to “normal” from “split” by the directory entry merge program 0264. The local CH table 0850 for an inode with status 0840 as “split” is a CH table (with the same structure as explained in FIG. 4) which consists of the MDSs 0110 where the directory entries are split. The local CH table 0850 is empty for an inode with status 0840 as “normal.” The count 0860 is the number of directory entries for a directory. The checkpoint 0870 is initially set to 0, and will be used by the directory entry split program 0263 and directory entry merge program 0264 (which will be further described herein below).

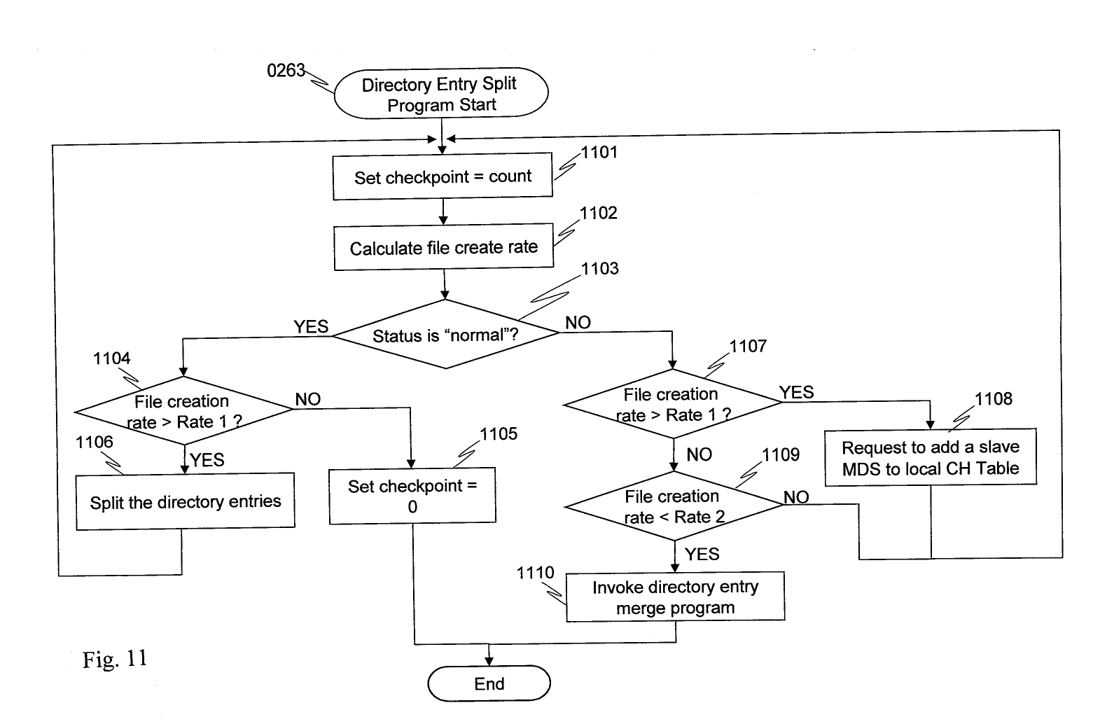

To create a file under a parent directory, the client 0130 first sends the request to a MDS 0110, referred to as the current MDS. It may be noted that the current MDS may not be the master MDS where the file should be stored due to the directory distribution (refer to FIG. 6) or directory entry split (refer to FIG. 11). The current MDS will transfer the request to the master MDS where the file should be stored. It should be noted further that the inode of the parent directory is available at the current MDS due to the path traversal process (refer to FIG. 7).

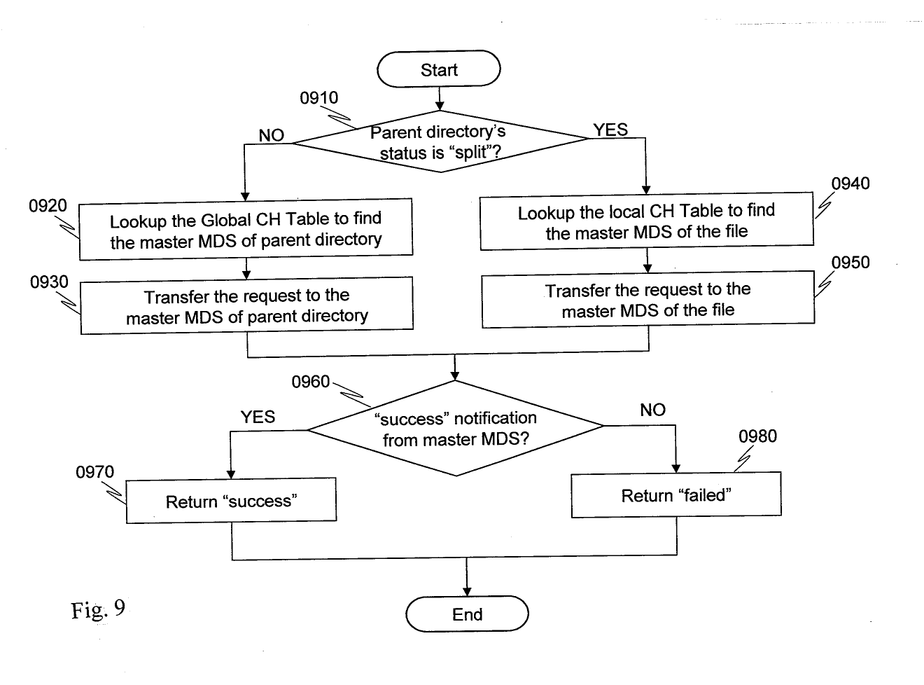

FIG. 9 is a flow diagram illustrating the exemplary steps of transferring a file access request from the current MDS to the master MDS of the file, using, for example, a remote procedure call (RPC). In Step 0910, the current MDS checks if the status 0840 in the parent directory inode is “split.” If NO, in Step 0920, the current MDS calculates the hash value of the parent inode number, and finds the master MDS of the parent directory, by looking up the global CH table 0266. In Step 0930, the current MDS transfers the request to the master MDS of parent directory. On the other hand, if YES in Step 0910, in Step 0940, the current MDS then looks up the local CH table 0850 in the parent directory inode for the MDS 0110 (referred to as the master MDS of the file) which manages the ID range in which the hash value 0540 of the file falls in. It should be noted that if the parent directory's status 0840 is not “split” (i.e., “normal”), the master MDS of parent directory is also the master MDS of the file. In Step 0950, the current MDS transfers the request to the master MDS of the file. Thereafter, in Step 0960, the current MDS checks if “success” notification is received from the master MDS (found in Step 0920 or Step 0940). If YES, the current MDS returns “success” to the client 0130 in Step 0970. If NO, the current MDS returns “failed” to the client 0130 in Step 0980.

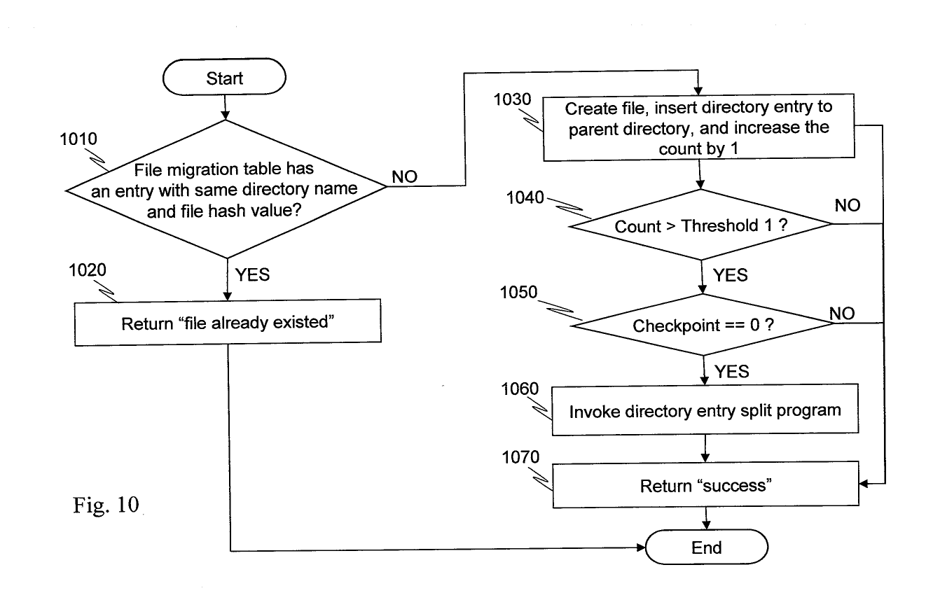

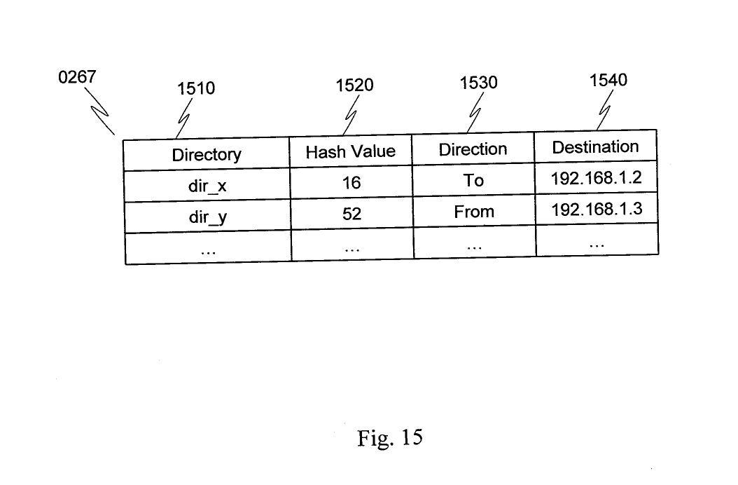

FIG. 10 is a flow diagram illustrating the exemplary steps of file creation, executed by the master MDS of the file found in Step 0920 or Step 0940, referred to as the current MDS. In Step 1010, the current MDS first checks if file migration table 0267 (refer to FIG. 15) has an entry with the same directory name and the same file hash value. If YES, in Step 1020, the current MDS returns “file already existed.” If NO, in Step 1030, the current MDS creates the file, inserts a directory entry to the parent directory, and increases the parent directory inode's count 0860 by 1. Thereafter, in Step 1040, the current MDS checks if the count 0860 is greater than a predefined threshold, referred to as Threshold 1. If NO, the current MDS then returns “success” in Step 1070. If YES, in Step 1050, the current MDS further checks if the parent directory inode's checkpoint 0870 value is 0. If NO, the current MDS then returns “success” in Step 1070. If YES, in Step 1060, the current MDS invokes the directory entry split program 0263 to split the parent directory entries (see FIG. 11), and returns “success” in Step 1070.

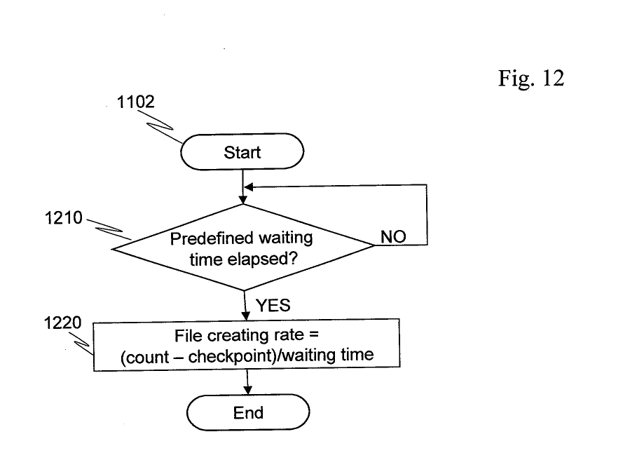

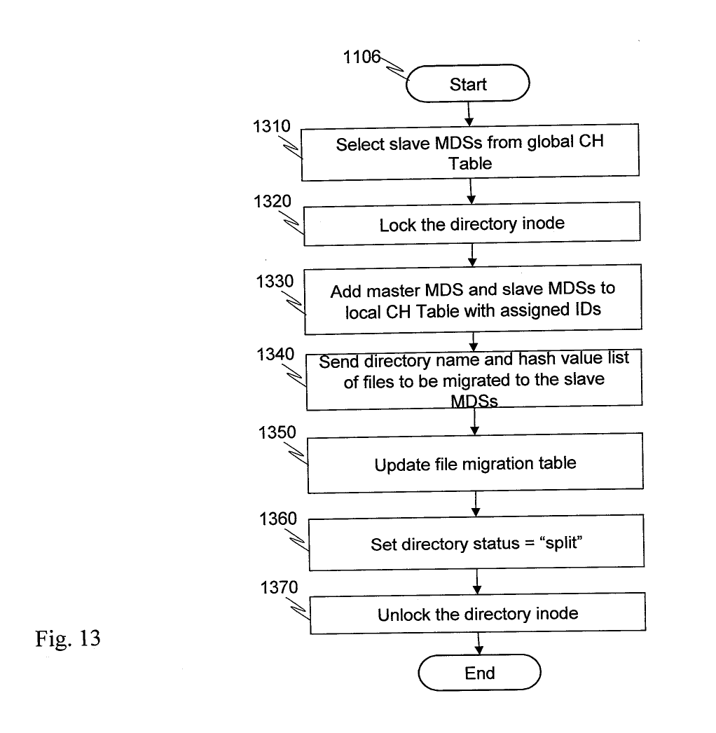

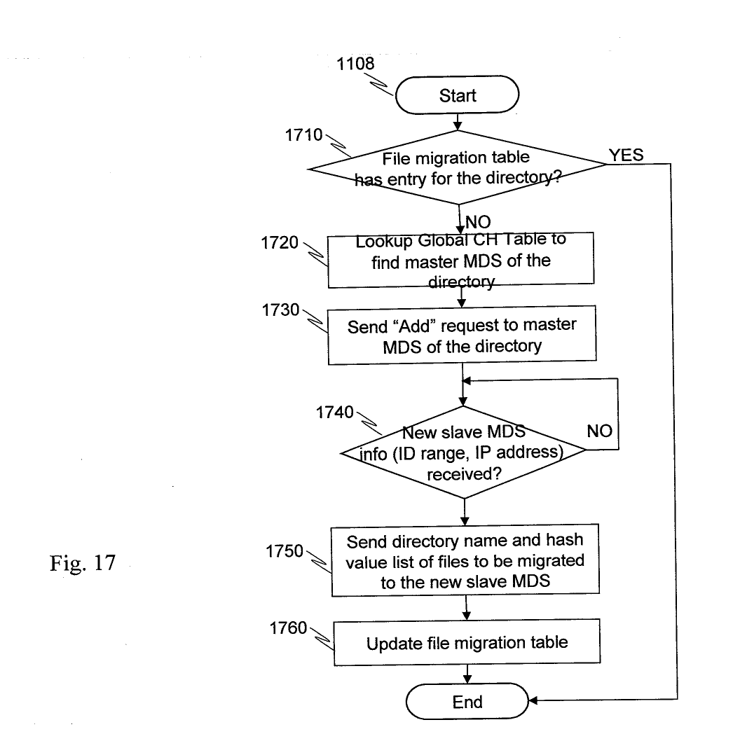

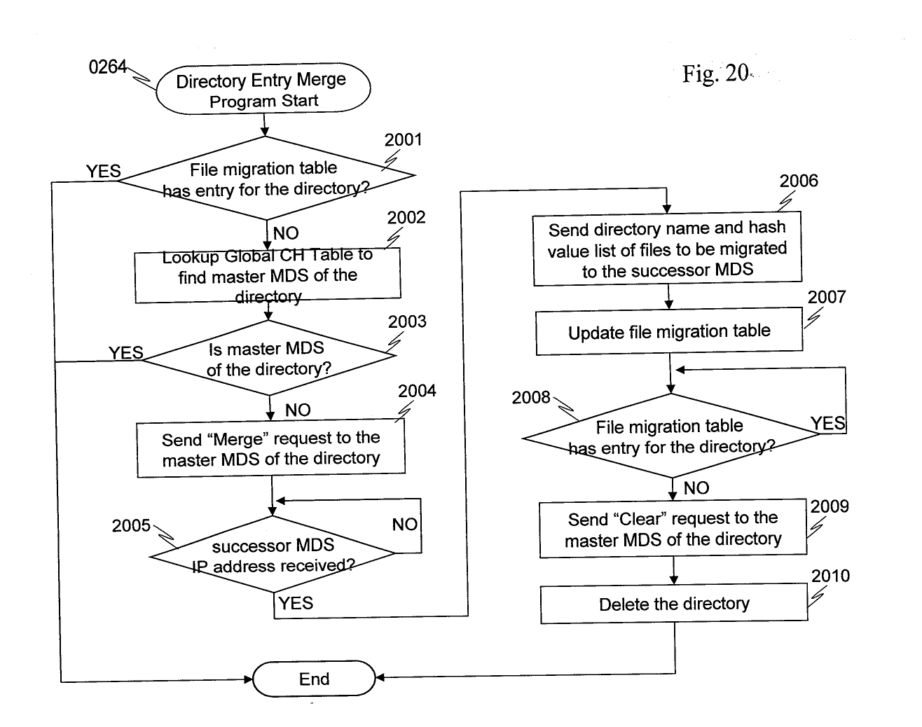

FIG. 11 is a flow diagram illustrating exemplary steps of the directory entry split program 0263, executed by a MDS 0110, referred to as current MDS. In Step 1101, the current MDS sets the value of checkpoint 0870 of the directory as the value of count 0860. In Step 1102, the current MDS calculates the file creation rate of the directory (see FIG. 12). In Step 1103, the current MDS checks if the directory's status 0840 is “normal.” If YES in Step 1103, in Step 1104, the current MDS further checks if the file creation rate is larger than a predefined threshold, referred to as Rate 1 (split threshold) (e.g., 1000 files/second). If NO, the current MDS resets the checkpoint to 0 in Step 1105, and terminates the program. If YES, in Step 1106, the current MDS starts the process to split the directory entries (see FIG. 13), and then repeats Step 1101. It should be noted that as the directory's status 0840 is “normal,” the current MDS is also the master MDS of the directory. If NO in Step 1103, in Step 1107, the current MDS further checks if the file creation rate is higher than Rate 1. If YES in Step 1107, in Step 1108, the current MDS requests the master MDS of the directory to add a slave MDS to the local CH table 0850 (see FIG. 17), and then repeats Step 1101. If NO in Step 1107, in Step 1109, the current MDS further checks if the file creation rate is lower than a predefined threshold, referred to as Rate 2 (merge threshold). If NO, the current MDS repeats Step 1101. If YES, in Step 1110, the current MDS invokes a directory entry merge program 0264 to migrate the directory entries (see FIG. 20).

FIG. 12 is a flow diagram illustrating the exemplary steps constituting Step 1102 to calculate the file create rate. In Step 1210, the current MDS waits until a predefined waiting time (e.g., a few seconds) has elapsed. It should be noted that during the waiting time, more files may be created under the directory. In Step 1220, the file creation rate is calculated as (count−checkpoint)/waiting time.

FIG. 13 is a flow diagram illustrating the exemplary steps constituting Step 1106 to split the directory entries. In Step 1310, the master MDS selects other MDSs 0110, referred to as slave MDSs, from the global CH Table 0266. The number of slave MDSs to be selected is calculated as ┌file creation rate/Rate 1┐−1 (this means rounding up the value of the ratio of (file creation rate/Rate 1) to the next integer value and subtracting 1), where the file creation rate is obtained in Step 1220. For example, if the file creation rate calculated in Step 1220 is 3500 files/second, and Rate 1 is 1000 files/second, then the number of slave MDSs will be 4−1=3. Further, the slave MDSs can be selected from the global CH Table 0266 randomly or from those which manage smaller ID ranges. In Step 1320, the master MDS locks the directory inode. In Step 1330, the master MDS adds itself and the slave MDSs to the local CH table 0850 with assigned IDs. The ID of each MDS 0110 in the local CH Table 0850 is assigned by the master MDS, so that each MDS will manage an equivalent ID range.

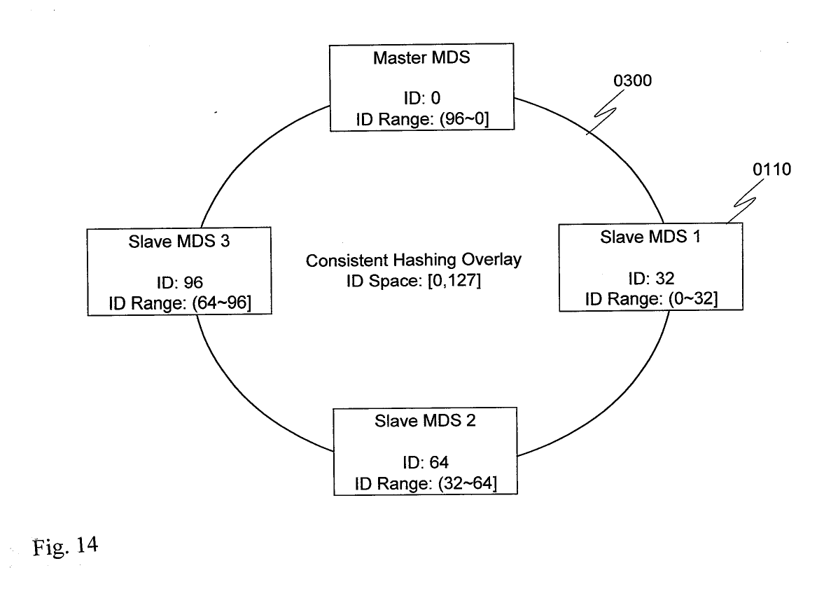

FIG. 14 shows an example of the IDs assigned to the MDSs in the local CH table 0850. As seen in the example, there are four MDSs 0110 (the master MDS and 3 slave MDSs) in the local CH table 0850, which logically form a consistent hashing overlay with ID space [0,127]. The master MDS always has ID 0, and the IDs assigned to the slave MDSs are 32, 64, and 96, so that each of the MDS in the local CH table 0850 manages ¼ of the ID space.

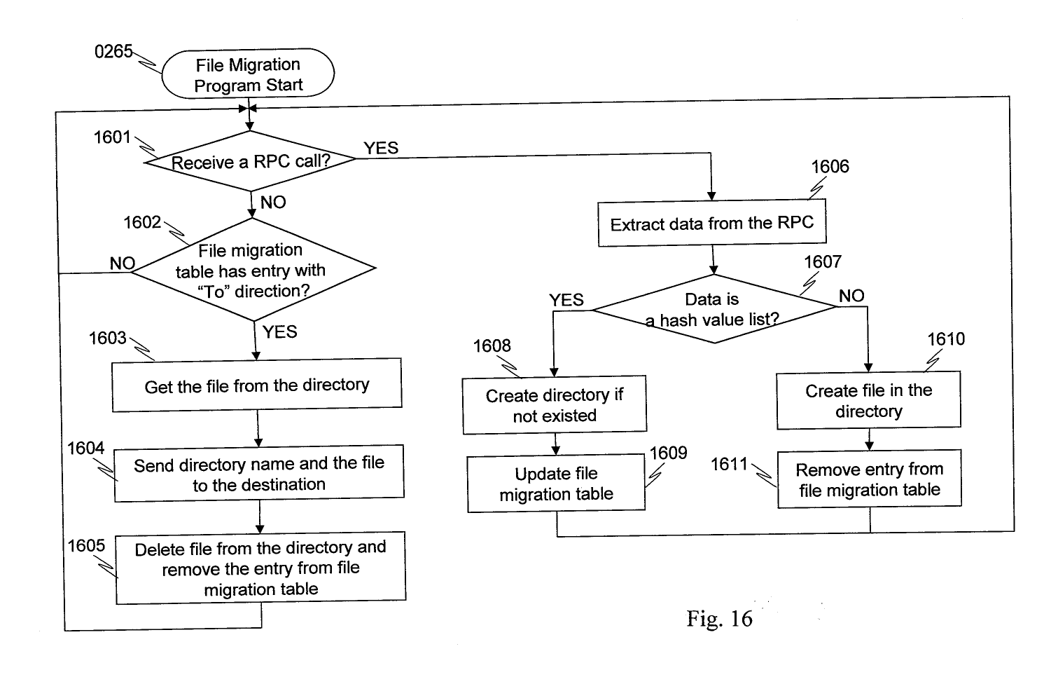

Referring back to FIG. 13, in Step 1340, the master MDS sends the directory name and hash value list of files to be migrated to the slave MDSs, through a RPC call which will be received by the file migration program 0267 in the slave MDSs (refer to FIG. 16). The hash value list sent to each slave MDS consists of the files' hash values 0540 which fall in the ID range managed by the slave MDS in the local CH table 0850. In Step 1350, the master MDS then updates the file migration table 0267 (see FIG. 15), by adding entries with the directory name, file hash values sent in Step 1340, direction as “To,” and destination as the slave MDSs. In Step 1360, the master MDS sets the directory status as “split,” and unlocks the directory inode in Step 1370. Henceforth, files can be created in parallel to the master MDS and the slave MDSs.

FIG. 15 shows an example of the structure of a file migration table 0267, which consists of, but is not limited to, four columns, including directory 1510, hash value 1520, direction 1530, and destination 1540. The directory 1510 is a directory name. The hash value 1520 is a hash value of a file in the directory. The direction 1530 is either “To” or “From.” The destination 1540 is the IP address of the MDS to or from which the file will be migrated. For an entry in the file migration table 0267 with direction as “To,” the corresponding file will be migrated by the file migration program 0265, executed in every MDS (see FIG. 16).

FIG. 16 is a flow diagram illustrating exemplary steps of the file migration program 0265. In Step 1601, the MDS checks if a RPC call is received. If NO in Step 1601, in Step 1602, the MDS further checks if there is an entry in the file migration table with direction as “To.” If NO in step 1602, the MDS repeats Step 1601. If YES in step 1602, in Step 1603, the MDS gets the corresponding file (including inode and content) from the directory 1510 which has the same hash value (1520 in FIGS. 15 and 0540 in FIG. 5). In Step 1604, the MDS sends the directory name and file to the destination 1540 through a RPC call, which will be received by the file migration program 0265 in the destination MDS. Thereafter, in Step 1605, the MDS deletes the file from the directory 1510, and removes the entry from the file migration table 0267. If YES in Step 1601, in Step 1606, the MDS first extracts data from the RPC call. In Step 1607, the MDS then checks if the data is a hash value list. If YES in Step 1607, in Step 1608, the MDS creates the directory if the directory does not exist. In Step 1609, the MDS then updates the file migration table 0267, by adding entries with the received data (directory name and hash values), and sets the entries with direction as “From” and destination as the MDS from which the RPC is sent. If NO in Step 1607, which means that the RPC is a file migration and the received data is a directory name and a file, in Step 1610, the MDS creates the file to the directory. In Step 1611, the MDS removes the entry with the directory name and file hash value from the file migration table 0267.

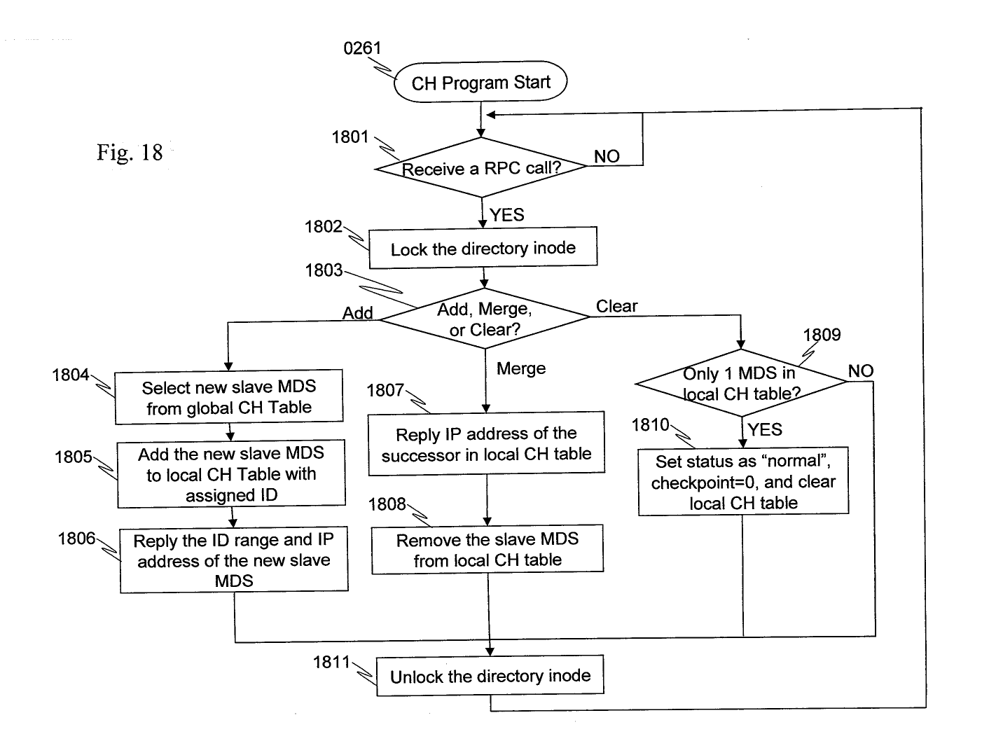

FIG. 17 is a flow diagram illustrating the exemplary steps constituting the Step 1108 to add a slave MDS to the local CH table 0850. In Step 1710, the current MDS checks if the file migration table 0267 has entry for the directory. If YES, the current MDS will not send out the request, as there are still files to be migrated to or from the current MDS, and the procedure ends. If NO, in Step 1720, the current MDS finds the master MDS of the directory, by looking up the global CH table 0266, and in Step 1730, sends an “Add” request to the master MDS of the directory, through a RPC call which will be received by the CH program 0261 (refer to FIG. 18) in the master MDS. It may be noted that the current MDS may itself be the master MDS of the directory. In Step 1740, the current MDS waits to receive the information (ID range and IP address) of new slave MDS. In Step 1750, the current MDS sends the directory name and hash value list of files to be migrated to the new slave MDS, through a RPC call which will be received by the file migration program 0265 (refer to FIG. 16) in the new slave MDS. The hash value list sent to the new slave MDS consists of the files' hash values 0540 which fall in the ID range managed by the new slave MDS. In Step 1760, the current MDS then updates the file migration table 0267, by adding entries with the directory name, file hash values sent in Step 1750, direction as “To,” and destination as the new slave MDS.

FIG. 18 is a flow diagram illustrating exemplary steps of the CH program 0261, executed by the master MDS of a directory. In Step 1801, the master MDS checks if a RPC call is received. If NO, the master MDS repeats Step 1801. If YES, in Step 1802, the master MDS locks the directory inode. In Step 1803, the master MDS then checks if the received request is to add a new slave MDS, or to merge directory entries, or to clear up the local CH table 0850. If it is to add a new slave MDS, in Step 1804, the master MDS selects a new slave MDS from global CH table 0266. The new slave MDS can be selected randomly or from those which manage smaller ID ranges. In Step 1805, the master MDS adds the new slave MDS to the local CH table 0850 with an assigned ID. The ID of the new slave MDS is assigned by the master MDS, so that the new slave MDS will take over half of the ID range managed by the MDS which sends the request. In Step 1806, the master MDS sends a reply with the ID range and IP address of the new slave MDS to the MDS which sends the request.

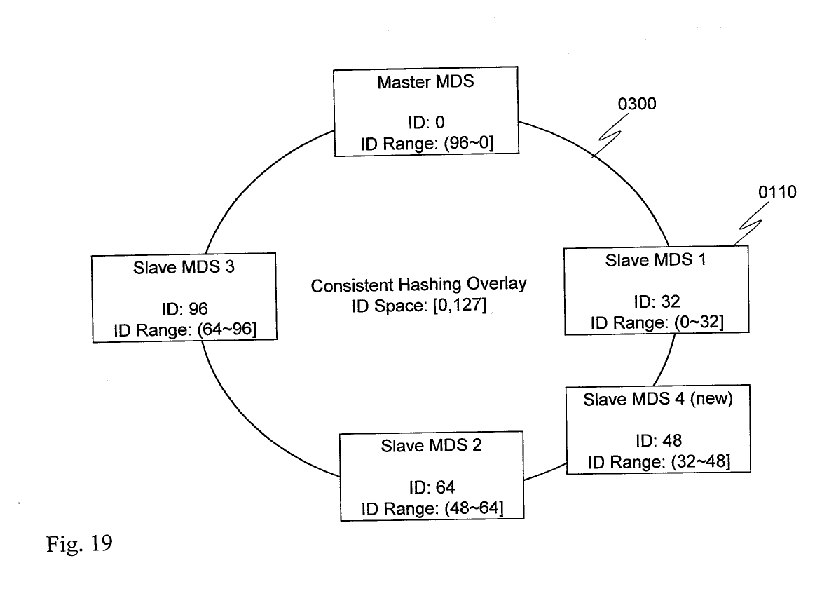

FIG. 19 shows an example of the ID assigned to the new slave MDS in the local CH table 0850. As seen in the example, the slave MDS with ID 64 requests to add a new slave MDS. The master MDS then assigns ID 48 to the new slave MDS, so that both the MDS with ID 64 and the new slave MDS manage an equivalent ID range (namely, (48˜64] for slave MDS 2 with ID 64 and (32˜48] for new slave MDS 4 with ID 48).

Referring back to FIG. 18, if the request is to merge directory entries as determined in Step 1803, in Step 1807, the master MDS sends a reply with the IP address of the successor MDS (whose ID is numerically closest clockwise in the ID space of the local CH table) to the slave MDS which sends the request, and then removes the slave MDS from the local CH table 0850, in Step 1808. If, in Step 1803, the request is to clear up the local CH table 0850, in Step 1809, the master MDS further checks if there is only one MDS left in the local CH table. If YES, the master MDS then sets the directory inode's status 0840 to “normal” and checkpoint 0870 to “0,” and clears the local CH table 0850. Lastly (after Step 1806 or Step 1808 or Step 1810), in Step 1811, the master MDS unlocks the directory inode.

FIG. 20 is a flow diagram illustrating exemplary steps of the directory entry merge program 0264 (as performed in Step 1110 of FIG. 11). In Step 2001, the current MDS checks if the file migration table 0267 has entry for the directory. If YES, the current MDS will not send out the request, as there are still files to be migrated to or from the current MDS, and the procedure ends. If NO, in Step 2002, the current MDS finds the master MDS of the directory, by looking up global CH table 0266. In Step 2003, the current MDS further checks if it is the master MDS itself. If YES, the current MDS will not send out the request and the procedure ends. If NO, in Step 2004, the current MDS sends “Merge” request to the master MDS of the directory, through a RPC call which will be received by the CH program 0261 (refer to FIG. 18) in the master MDS. In Step 2005, the current MDS waits to receive the information (i.e., IP address) of the successor MDS in the local CH table 0850. In Step 2006, the current MDS sends the directory name and hash value list of files to be migrated to the successor MDS, through a RPC call which will be received by the file migration program 0265 (refer to FIG. 16) in the successor MDS. The hash value list consists of hash values 0540 of all the files in the directory in the current MDS. In Step 2007, the current MDS then updates the file migration table 0267, by adding entries with the directory name, file hash values sent in Step 2006, direction as “To,” and destination as the successor MDS. In Step 2008, the current MDS waits until all the files in the directory have been migrated to the successor MDS, i.e., the file migration table 0267 has no entry for the directory. In Step 2009, the current MDS sends “Clear” request to the master MDS of the directory, through a RPC call which will be received by the CH program 0261 (refer to FIG. 18) in the master MDS. Lastly, in Step 2010, the current MDS deletes the directory.

With the aforementioned directory entry split/merge process (refer to FIG. 11 and FIG. 20), files can be created in parallel to the master MDS and slave MDSs of a directory. The process to read a file in a directory and the process to read all the directory entries in a directory (readdir) are explained herein below.

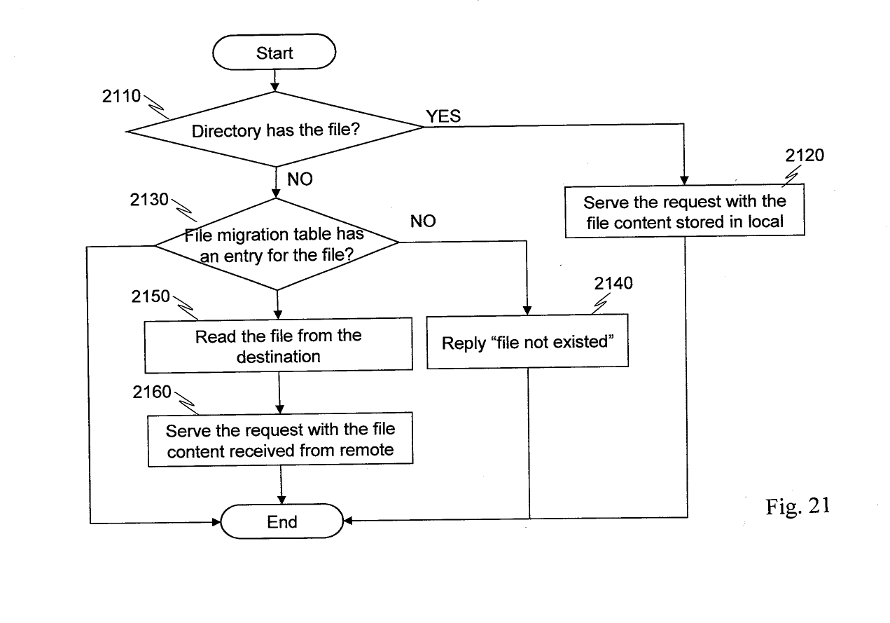

FIG. 21 is a flow diagram illustrating exemplary steps of a file read process in the master MDS of the file. As explained in FIG. 9 above, to read a file in a directory, the request will first be transferred to the master MDS of the file. In Step 2110, the master MDS checks if the directory has the requested file. If YES, in Step 2120, the master MDS serves the request with the file content stored in local. If NO, in Step 2130, the master MDS further checks if the file migration table 0267 has an entry for the file with direction 1530 as “From.” If NO, the master MDS replies “file not existed” to the requester in Step 2140. If YES, the master MDS then reads the file content from the destination 1540 in Step 2150, and serves the request with the file content received from the destination in Step 2160.

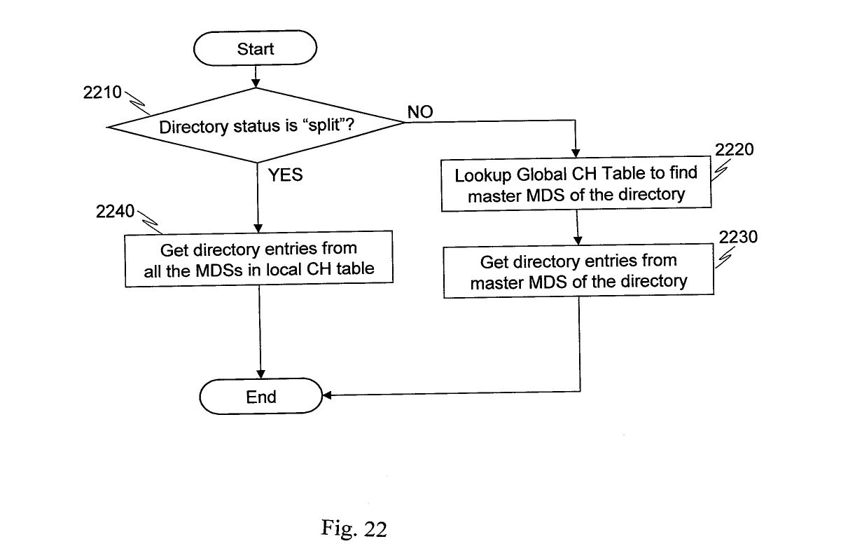

FIG. 22 is a flow diagram illustrating exemplary steps of the process to read all the directory entries in a directory (readdir), executed in a MDS 0110 which receives the request, referred to as the current MDS. In Step 2210, the current MDS checks if the directory inode status 0840 is “split.” If NO, in Step 2220, the current MDS first finds the master MDS of the directory by looking up the global CH table 0266, and gets the directory entries from the master MDS via a remote procedure call in Step 2230. If YES in Step 2210, the current MDS gets the directory entries from all the MDSs in the local CH table 0850 in step 2240.

### Embodiment 2

A second embodiment of the present invention will be described next. The explanation will mainly focus on the differences from the first embodiment. In the first embodiment, to split directory entries, the master MDS of the directory assigns IDs to the slave MDSs in the way that each MDS in the local CH table 0850 manages an equivalent ID range (see Step 1330 of FIG. 13). Similarly, to add a new slave MDS to the local CH table 0850, the master MDS assigns an ID to the new slave MDS so that both the new slave MDS and its successor MDS manage an equivalent ID range (Step 1805 of FIG. 18). The aforementioned ID assignment does not consider the capability of each MDS (in terms of CPU power, disk IO throughput, or the combination), and may cause workload imbalance to the MDSs in the local CH table 0850. Therefore, in the second embodiment, the master MDS assigns an ID to a slave MDS based on the capability of the slave MDS.

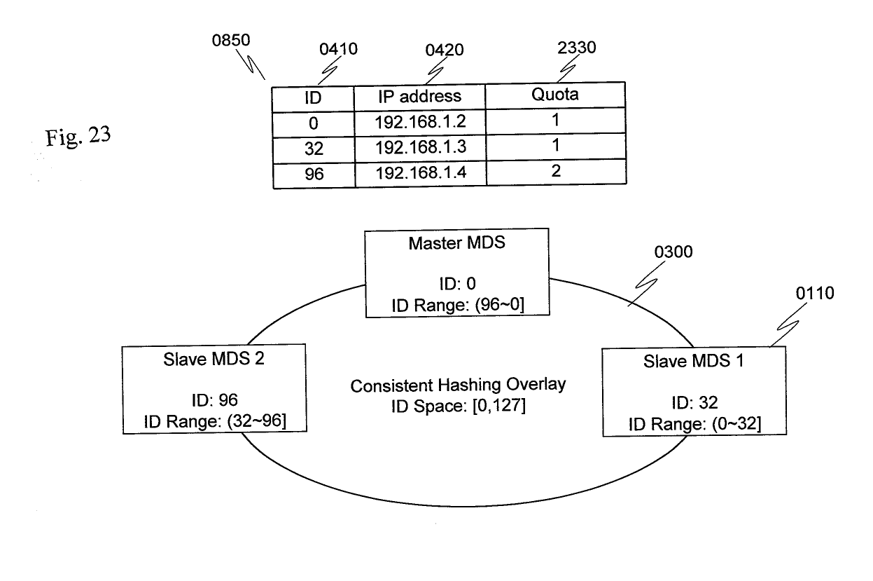

To this end, for a local CH table 0850, a quota column 2330 is added, as shown in FIG. 23 (as compared to the table of FIG. 4). The quota 2330 for the master MDS (which has ID 0) is always 1. The quota 2330 for a slave MDS is calculated as the ratio between the capability of the slave MDS to that of the master MDS. FIG. 23 also shows an example of three MDSs 0110 (the master MDS and 2 slave MDSs) in the local CH table 0850, which logically forms a consistent hashing overlay with ID space [0,127]. The master MDS has ID 0, and the IDs assigned to the slave MDSs are 32 and 96, so that each of the MDSs in the local CH table 0850 manages an ID space proportional to its quota.

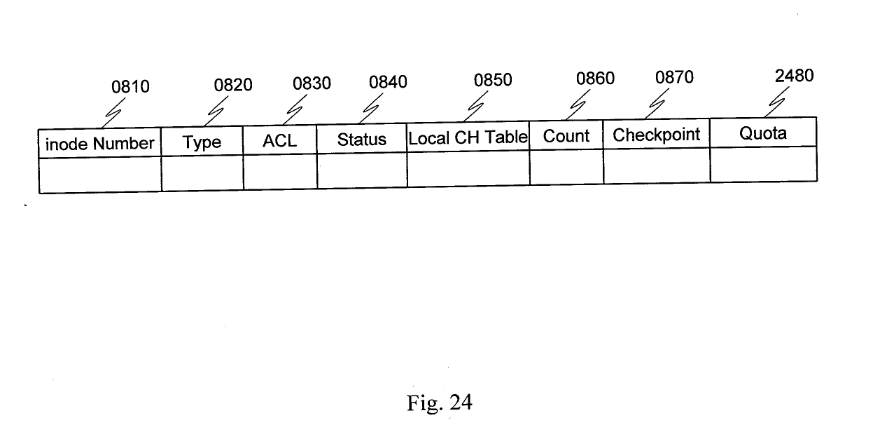

Further, in Step 1340 of FIG. 13, the master MDS also sends the quota 2330 to the slave MDSs according to the second embodiment. When the slave MDS creates the directory in Step 1610 of FIG. 16, the quota 2330 is stored in the directory inode. FIG. 24 shows an example of the structure of an inode, where a quota column 2480 is added (as compared to the inode of FIG. 8). Furthermore, in Step 1107 of FIG. 11, the MDS 0110 will only perform Step 1108 (to request to add a slave MDS to local CH table) if file creation rate is larger than quota*Rate 1.

Similarly, to add a new slave MDS to the local CH table, in Step 1805 of FIG. 18, the master MDS assigns an ID to the new slave MDS, so that the new slave MDS will take over the ID range managed from the successor MDS based on its capability. Therefore, with the second embodiment, the ID range managed by each MDS in the local CH table is proportional to the capability of the MDS. The system resource utilization is improved and hence better file creation performance can be achieved.

### Embodiment 3

A third embodiment of the present invention will be described in the following. The explanation will mainly focus on the differences from the first and second embodiments. In the first and second embodiments, a global CH table 0266 which consists of all the MDSs 0110 in the system is maintained by each MDS. A client 0130 has no hashing capability and does not maintain the global CH table. As the clients have no knowledge on where a directory is stored, the clients may send a directory access request to a MDS 0110 where the directory is not stored, incurring additional communication cost between the MDSs. In the third embodiment, a client can execute the same hash function as in the CH program 0261 and maintain the global CH table 0266. A client can then send a directory access request directly to the master MDS of the directory by looking up the global CH table 0266, so that communication cost between MDSs can be reduced.

### Embodiment 4

A fourth embodiment of the present invention will be described in the following. The explanation will mainly focus on the differences from the first embodiment. In the first embodiment, clients 0130 first access the metadata from MDSs 0110 and then access file contents directly from DSs 0120. In other words, MDSs 0110 are not in the access path during file contents access. However, a Client 0130 may not have the capability to differentiate between the process of metadata access and file contents access, i.e., to send metadata access to MDSs and send file content access to DSs. Instead, a Client 0130 may send both metadata access and file contents access to MDSs 0110. Therefore, in the fourth embodiment, the MDSs 0110 will serve both metadata access and file content access from Clients 0130.

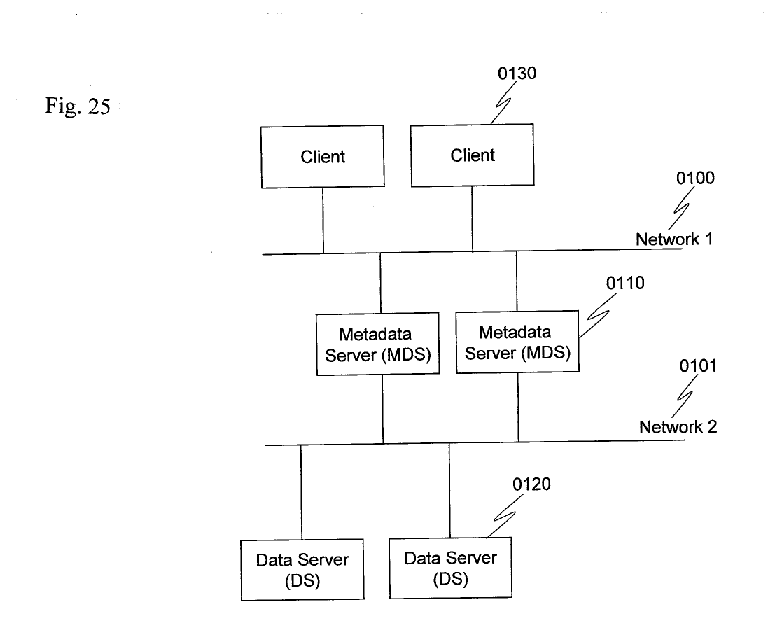

FIG. 25 is an exemplary diagram of an overall system according to the fourth embodiment. The system includes a plurality of Metadata Servers (MDSs) 0110, Data Servers (DSs) 0120, and Clients 0130. Clients 0130 and MDSs 0110 are connected to a network 1 0100, while MDSs 0110 and DSs 0120 are connected to a network 2 0101. Clients 0130 access both the metadata and file contents from MDSs 0110 through network 1 0100. For metadata access, MDSs will serve the requests as described in the first embodiment. For file contents access, if the access involves read operation, the MDSs 0110 will retrieve file contents from DSs 0120 through network 2 0101, and send back file contents to Clients 0130 through network 1 0100. On the other hand, if the access involves write operation, the MDSs 0110 will receive the file contents from Clients 0130 through network 1 0100, and store the file contents to DSs 0120 through network 2 0101.

Of course, the system configuration illustrated in FIG. 1 and FIG. 25 are purely exemplary of information systems in which the present invention may be implemented, and the invention is not limited to a particular hardware configuration. The computers and storage systems implementing the invention can also have known I/O devices (e.g., CD and DVD drives, floppy disk drives, hard drives, etc.) which can store and read the modules, programs and data structures used to implement the above-described invention. These modules, programs and data structures can be encoded on such computer-readable media. For example, the data structures of the invention can be stored on computer-readable media independently of one or more computer-readable media on which reside the programs used in the invention. The components of the system can be interconnected by any form or medium of digital data communication, e.g., a communication network. Examples of communication networks include local area networks, wide area networks, e.g., the Internet, wireless networks, storage area networks, and the like.

In the description, numerous details are set forth for purposes of explanation in order to provide a thorough understanding of the present invention. However, it will be apparent to one skilled in the art that not all of these specific details are required in order to practice the present invention. It is also noted that the invention may be described as a process, which is usually depicted as a flowchart, a flow diagram, a structure diagram, or a block diagram. Although a flowchart may describe the operations as a sequential process, many of the operations can be performed in parallel or concurrently. In addition, the order of the operations may be re-arranged.

As is known in the art, the operations described above can be performed by hardware, software, or some combination of software and hardware. Various aspects of embodiments of the invention may be implemented using circuits and logic devices (hardware), while other aspects may be implemented using instructions stored on a machine-readable medium (software), which if executed by a processor, would cause the processor to perform a method to carry out embodiments of the invention. Furthermore, some embodiments of the invention may be performed solely in hardware, whereas other embodiments may be performed solely in software. Moreover, the various functions described can be performed in a single unit, or can be spread across a number of components in any number of ways. When performed by software, the methods may be executed by a processor, such as a general purpose computer, based on instructions stored on a computer-readable medium. If desired, the instructions can be stored on the medium in a compressed and/or encrypted format.

From the foregoing, it will be apparent that the invention provides methods, apparatuses and programs stored on computer readable media for distributing directory entries to multiple metadata servers to improve the performance of file creation under a single directory, in a distributed system environment. Additionally, while specific embodiments have been illustrated and described in this specification, those of ordinary skill in the art appreciate that any arrangement that is calculated to achieve the same purpose may be substituted for the specific embodiments disclosed. This disclosure is intended to cover any and all adaptations or variations of the present invention, and it is to be understood that the terms used in the following claims should not be construed to limit the invention to the specific embodiments disclosed in the specification. Rather, the scope of the invention is to be determined entirely by the following claims, which are to be construed in accordance with the established doctrines of claim interpretation, along with the full range of equivalents to which such claims are entitled.

What is claimed is:

1. A plurality of MDSs (metadata servers) in a distributed storage system which includes data servers storing file contents to be accessed by clients, each MDS having a processor and a memory and storing file system metadata to be accessed by the clients,
wherein directories of a file system namespace are distributed to the MDSs based on a hash value of inode number of each directory, each directory is managed by a MDS as a master MDS of the directory, and a master MDS may manage one or more directories;
wherein when a directory grows with a high file creation rate that is greater than a preset split threshold, the master MDS of the directory constructs a consistent hashing overlay with one or more MDSs as slave MDSs and splits directory entries of the directory to the consistent hashing overlay based on hash values of file names under the directory;
wherein the consistent hashing overlay has a number of MDSs including the master MDS and the one or more slave MDSs, the number being calculated based on the file creation rate;
wherein when the directory continues growing with a file creation rate that is greater than the preset split threshold, the master MDS adds a slave MDS into the consistent hashing overlay and splits directory entries of the directory to the consistent hashing overlay with the added slave MDS based on hash values of file names under the directory.

2. The plurality of MDSs according to claim 1,
wherein when the file creation rate of the directory drops below a preset merge threshold, the master MDS removes a slave MDS from the consistent hashing overlay and merges the directory entries of the slave MDS to be removed to a successor MDS remaining in the consistent hashing overlay.

3. The plurality of MDSs according to claim 2, wherein each MDS includes a directory entry split module configured to:
calculate a file creation rate of a directory;
check whether a status of the directory is split or normal which means not split;
if the status is normal and if the file creation rate is greater than the preset split threshold, then split the directory entries for the directory to the consistent hashing overlay based on hash values of file names under the directory; and
if the status is split and if the file creation rate is greater than the preset split threshold, then send a request to the master MDS of the directory to add a slave MDS to the consistent hashing overlay if the MDS of the directory entry split module is not the master MDS, and add a slave MDS to the consistent hashing overlay if the MDS of the directory entry split module is the master MDS.

4. The plurality of MDSs according to claim 3, wherein each MDS maintains a global consistent hashing table which stores information of all the MDSs, and wherein splitting the directory entries by the directory entry split module of the master MDS for the directory comprises:
selecting one or more other MDSs as slave MDSs from the global consistent hashing table, wherein the number of slave MDSs to be selected is calculated by rounding up a value of a ratio of (the file creation rate/the preset split threshold) to a next integer value and subtracting 1;
creating the same directory to each of the selected slave MDSs; and
splitting the directory entries to the selected slave MDSs based on the hash values of file names under the directory, by first sending only the hash values of the file names to the slave MDSs and migrating files corresponding to the file names later;
wherein files can be created in parallel to the master MDS and the slave MDSs as soon as hash values have been sent to the slave MDSs.

5. The plurality of MDSs according to claim 4, wherein each MDS comprises a file migration module configured to:
as a source MDS for file migration, send a directory name of the directory and a file to be migrated to a destination MDS; and
as a destination MDS for file migration, receive the directory name of the directory and the file to be migrated from the source MDS, and create the file to the directory.

6. The plurality of MDSs according to claim 3, wherein each MDS maintains a global consistent hashing table which stores information of all the MDSs, and wherein the directory entry split module which sends a request to the master MDS of the directory to add a slave MDS to the consistent hashing overlay is configured to:
find the master MDS of the directory by looking up the global consistent hashing table;
send an “Add” request to the master MDS of the directory;
receive information of a new slave MDS to be added; and
send a directory name of the directory and hash values of file names of files to be migrated to the new slave MDS.

7. The plurality of MDSs according to claim 3,
wherein each MDS maintains a global consistent hashing table which stores information of all the MDSs;
wherein each MDS includes a consistent hashing module;
wherein for adding a new slave MDS into the consistent hashing overlay, the consistent hashing module in the master MDS is configured to select the new slave MDS from the global consistent hashing table, assign to the new slave MDS a unique ID representing an ID range of hash values in the consistent hashing overlay to be managed by the new slave MDS, add the new slave MDS to the consistent hashing overlay, and, if the new slave MDS is added in response to a request from another MDS, then send a reply with the unique ID and an IP address of the new slave MDS to the MDS which sent the request for adding the new slave MDS; and
wherein for merging directory entries of a MDS which is to be removed to a successor MDS, the consistent hashing module of the master MDS is configured to send the IP address of the successor MDS to the MDS which is to be removed, and remove the MDS from the consistent hashing overlay.

8. The plurality of MDSs according to claim 7,
wherein the unique ID assigned to the new slave MDS represents an ID range of hash values equal to half of the ID range of hash values, which is managed by the MDS that sent the request for adding the new slave MDS, prior to adding the new slave MDS.

9. The plurality of MDSs according to claim 3,
wherein each MDS maintains a global consistent hashing table which stores information of all the MDSs;
wherein each MDS includes a directory entry merge module;
wherein the directory entry split module is configured to, if the status is split and if the file creation rate is smaller than the preset merge threshold, then invoke the directory entry merge module to merge the directory entries of the MDS to be removed; and
wherein the invoked directory entry merge module is configured to:
find the master MDS of the directory by looking up the global consistent hashing table; and
if the MDS of the invoked directory merge module is not the master MDS of the directory, then send a “Merge” request to the master MDS of the directory to merge the directory entries of the MDS to a successor MDS in the consistent hashing overlay, receive information of the successor MDS, send a directory name of the directory and hash values of file names of files to be migrated to the successor MDS and migrate files corresponding to the file names later, and delete the directory from the MDS to be removed.

10. The plurality of MDSs according to claim 2,
wherein the master MDS of a directory includes a directory inode comprising an inode number column of a unique identifier assigned for the directory and for each file in the directory, a type column indicating “File” or “Directory,” an ACL column indicating access permission of the file or directory, a status column for the directory indicating split or normal which means not split, a local consistent hashing table column, a count column indicating a number of directory entries for the directory, and a checkpoint column;
wherein the master MDS constructs a local consistent hashing table associated with the consistent hashing overlay, which is stored in the local consistent hashing table column if the status is split; and
wherein a checkpoint under the checkpoint column is initially set to 0 and can be changed when the directory entries are split or merged.

11. The plurality of MDSs according to claim 1,
wherein the master MDS of the directory has a quota equal to 1 and wherein each slave MDS has a quota equal to a ratio between capability of the slave MDS to capability of the master MDS; and
wherein each MDS includes a directory entry split module configured to:
calculate a file creation rate of a directory;
check whether a status of the directory is split or normal which means not split;
if the status is normal and if the file creation rate is greater than the preset split threshold multiplied by the quota of the MDS of the directory entry split module, then split the directory entries for the directory to the consistent hashing overlay based on hash values of file names under the directory; and
if the status is split and if the file creation rate is greater than the preset split threshold multiplied by the quota of the MDS of the directory entry split module, then send a request to the master MDS of the directory to add a slave MDS to the consistent hashing overlay.

12. The plurality of MDSs according to claim 11,
wherein each MDS maintains a global consistent hashing table which stores information of all the MDSs;
wherein each MDS includes a consistent hashing module;
wherein for adding a new slave MDS into the consistent hashing overlay, the consistent hashing module in the master MDS is configured to select the new slave MDS from the global consistent hashing table, assign to the new slave MDS a unique ID representing an ID range of hash values in the consistent hashing overlay to be managed by the new slave MDS, add the new slave MDS to the consistent hashing overlay, and, if the new slave MDS is added in response to a request from another MDS, then send a reply with the unique ID and an IP address of the new slave MDS to the MDS which sent the request for adding the new slave MDS;
wherein for merging directory entries of a MDS which is to be removed to a successor MDS, the consistent hashing module of the master MDS is configured to send the IP address of the successor MDS to the MDS which is to be removed, and remove the MDS from the consistent hashing overlay; and
wherein the unique ID assigned to the new slave MDS represents an ID range of hash values equal to a portion of the ID range of hash values, which is managed by the MDS that sent the request for adding the new slave MDS, prior to adding the new slave MDS, such that a ratio of the portion of the ID range to be managed by the new slave MDS and a remaining portion of the ID range to be managed by the MDS that sent the request is equal to a ratio of the quota of the new slave MDS and the quota of the MDS that sent the request.

13. A distributed storage system which includes one or more clients, one or more data servers storing file contents to be accessed by the clients, and the plurality of MDSs of claim 1,
wherein each MDS maintains and each client maintains a global consistent hashing table which stores information of all the MDSs; and
wherein each client has a processor and a memory, and is configured to find the master MDS of the directory by looking up the global consistent hashing table and to send a directory access request of the directory directly to the master MDS of the directory.

14. A distributed storage system comprising:
the plurality of MDSs of claim 1;
one or more clients;
one or more data servers storing file contents to be accessed by the clients;
a first network coupled between the one or more clients and the MDSs; and
a second network coupled between the MDSs and the one or more data servers;
wherein the MDSs serve both metadata access from the clients and file content access from the clients via the MDSs to the data servers.

15. A method of distributing directory entries to a plurality of MDSs (metadata servers) in a distributed storage system which includes clients and data servers storing file contents to be accessed by the clients, each MDS storing file system metadata to be accessed by the clients, the method comprising:
distributing directories of a file system namespace to the MDSs based on a hash value of inode number of each directory, each directory being managed by a MDS as a master MDS of the directory, wherein a master MDS may manage one or more directories;
when a directory grows with a high file creation rate that is greater than a preset split threshold, constructing a consistent hashing overlay with one or more MDSs as slave MDSs and splits directory entries of the directory to the consistent hashing overlay based on hash values of file names under the directory, wherein the consistent hashing overlay has a number of MDSs including the master MDS and the one or more slave MDSs, the number being calculated based on the file creation rate; and
when the directory continues growing with a file creation rate that is greater than the preset split threshold, adding a slave MDS into the consistent hashing overlay and splits directory entries of the directory to the consistent hashing overlay with the added slave MDS based on hash values of file names under the directory.

16. The method according to claim 15, further comprising:
when the file creation rate of the directory drops below a preset merge threshold, removing a slave MDS from the consistent hashing overlay and merging the directory entries of the slave MDS to be removed to a successor MDS remaining in the consistent hashing overlay.

17. The method according to claim 15, further comprising:
calculating a file creation rate of a directory;
checking whether a status of the directory is split or normal which means not split;
if the status is normal and if the file creation rate is greater than the preset split threshold, then splitting the directory entries for the directory to the consistent hashing overlay based on hash values of file names under the directory; and
if the status is split and if the file creation rate is greater than the preset split threshold, then sending a request to the master MDS of the directory to add a slave MDS to the consistent hashing overlay if the MDS of the directory entry split module is not the master MDS, and adding a slave MDS to the consistent hashing overlay if the MDS of the directory entry split module is the master MDS.

18. The method according to claim 17, further comprising:
maintaining in each MDS a global consistent hashing table which stores information of all the MDSs,
wherein splitting the directory entries comprises:
selecting one or more other MDSs as slave MDSs from the global consistent hashing table, wherein the number of slave MDSs to be selected is calculated by rounding up a value of a ratio of (the file creation rate/the preset split threshold) to a next integer value and subtracting 1;
creating the same directory to each of the selected slave MDSs; and
splitting the directory entries to the selected slave MDSs based on the hash values of file names under the directory, by first sending only the hash values of the file names to the slave MDSs and migrating files corresponding to the file names later;
wherein files can be created in parallel to the master MDS and the slave MDSs as soon as hash values have been sent to the slave MDSs.

19. The method according to claim 15, wherein the master MDS of the directory has a quota equal to 1 and wherein each slave MDS has a quota equal to a ratio between capability of the slave MDS to capability of the master MDS, the method further comprising:
calculating a file creation rate of a directory;
checking whether a status of the directory is split or normal which means not split;
if the status is normal and if the file creation rate is greater than the preset split threshold multiplied by the quota of the MDS of the directory entry split module, then splitting the directory entries for the directory to the consistent hashing overlay based on hash values of file names under the directory; and
if the status is split and if the file creation rate is greater than the preset split threshold multiplied by the quota of the MDS of the directory entry split module, then sending a request to the master MDS of the directory to add a slave MDS to the consistent hashing overlay.

20. The method according to claim 19, further comprising:
maintaining in each MDS a global consistent hashing table which stores information of all the MDSs;
wherein adding a new slave MDS into the consistent hashing overlay comprises selecting the new slave MDS from the global consistent hashing table, assigning to the new slave MDS a unique ID representing an ID range of hash values in the consistent hashing overlay to be managed by the new slave MDS, adding the new slave MDS to the consistent hashing overlay, and, if the new slave MDS is added in response to a request from another MDS, then sending a reply with the unique ID and an IP address of the new slave MDS to the MDS which sent the request for adding the new slave MDS;
wherein merging directory entries of a MDS which is to be removed to a successor MDS comprises sending the IP address of the successor MDS to the MDS which is to be removed, and removing the MDS from the consistent hashing overlay; and
wherein the unique ID assigned to the new slave MDS represents an ID range of hash values equal to a portion of the ID range of hash values, which is managed by the MDS that sent the request for adding the new slave MDS, prior to adding the new slave MDS, such that a ratio of the portion of the ID range to be managed by the new slave MDS and a remaining portion of the ID range to be managed by the MDS that sent the request is equal to a ratio of the quota of the new slave MDS and the quota of the MDS that sent the request.
